(19) United States
(12) Patent Application Publication
(10) Pub. No.: US 2026/0347603 A1
(43) Pub. Date: Nov. 5, 2026

(54) SILANE MODIFIED POLYMER-BASED THERMALLY CONDUCTIVE COMPOSITION

(71) Applicant: Dow Silicones Corporation, Midland, MI (US)

(72) Inventors: Andrés E. Becerra, Midland, MI (US); Bizhong Zhu, Midland, MI (US); David M. Altergott, Bay City, MI (US)

(21) Appl. No.: 19/115,369

(22) PCT Filed: Oct. 17, 2023
(86) PCT No.: PCT/US2023/077055

§ 371 Date: Mar. 26, 2025

Related U.S. Application Data
(60) Provisional application No. 63/417,123, filed on Oct. 18, 2022.

(51) Int. Cl. C08L 71/02; C08G 65/336; C08G 77/08; C08K 3/22; C08K 5/00

(52) U.S. Cl. CPC C08L 71/02; C08K 3/22; C08K 5/0016; C08K 5/0041; C08G 65/336; C08G 77/08; C08K 2003/2227; C08K 2003/2296; C08K 2201/001; C08L 2203/20; C08L 2205/05

(57) ABSTRACT

The present invention relates to a composition comprising a) a thermally conductive filler; b) a first silane modified polymer functionalized with at least two C₁-C₄-alkyl-di-C₁-C₄-alkoxysilyl groups or tri-C₁-C₄-alkoxysilyl groups; c) a second silane modified polymer functionalized with one C₁-C₄-alkyl-di-C₁-C₄-alkoxysilyl group or one tri-C₁-C₄-alkoxysilyl group; and d) at least one dialkoxysilane selected from the group consisting of di-C₁-C₁₂-alkyl-di-C₁-C₄-alkoxysilanes and amino-C₁-C₁₂-alkyl-C₁-C₁₂-alkyl-di-C₁-C₄-alkoxysilanes. The composition of the present invention is useful as an intermediate for a curable composition, which can serve as an interlayer between a heat sink substrate and a heat generating substrate.

### BACKGROUND OF THE INVENTION

The present invention relates to a silane modified polymer-based (SMP-based) thermally conductive composition, more particularly a moisture curable SMP-based thermally conductive composition.

Thermal interface materials (TIMs) are used at the interface between a heat-generating electronic component and a heat sink to keep the electronic component from overheating. Liquid dispensed-TIMs are preferred over prefabricated elastomeric TIMs due to the ability of the liquid to conform to complex joint geometries, and to achieve thin bond-lines and low thermal resistance. It is desirable for the liquid-dispensed TIMs to cure to an elastomeric state in less than 2 weeks, and even more desirable at less than 24 hours. Post-cure hardness is ideally low enough to achieve vibration tolerance and easy debonding in non-adhesive applications. It is most desirable to achieve thermal conductivities of 1 W/m·K or higher of the cured elastomer.

Silicone-based TIMs provide advantages such as high temperature resistance and soft cured elastomers; nevertheless, some TIM users (particularly automakers) are averse to using silicones in their plants due to a real or perceived risk of surface contamination that would impair other processes such as painting or adhesive assembly.

Although polyurethane-based TIMs avoid silicone surface contamination concerns, the presence of unreacted isocyanate groups arising from polyurethane precursors creates handling and toxicity concerns. Moreover, undesirably high concentrations of potentially toxic plasticizers are often required to achieve acceptably high pre-cure flowability and low post-cure hardness. The need to reduce or eliminate plasticizers is further advantageous because plasticizers are known to migrate over the lifetime of the application. Furthermore, polyurethane-based TIMs are unstable to hot and humid conditions due to the propensity of urethane bonds to dissociate under such conditions. Accordingly, it would be desirable to discover thermal interface materials that a) have fast cure times to an elastomeric state; b) are free of silicone and isocyanates; and c) have a low plasticizer content.

### SUMMARY OF THE INVENTION

The present invention addresses a need in the art by providing, in one aspect, a composition comprising a) a thermally conductive filler; b) a first silane modified polymer functionalized with at least two C₁-C₄-alkyl-di-C₁-C₄-alkoxysilyl groups or two tri-C₁-C₄-alkoxysilyl groups; c) a second silane modified polymer functionalized with one C₁-C₄-alkyl-di-C₁-C₄-alkoxysilyl group or one tri-C₁-C₄-alkoxysilyl group; and d) at least one dialkoxysilane selected from the group consisting of di-C₁-C₁₂-alkyl-di-C₁-C₄-alkoxysilanes and amino-C₁-C₁₂-alkyl-C₁-C₁₂-alkyl-di-C₁-C₄-alkoxysilanes;

wherein the concentration of the thermally conductive filler is in the range of from 70 to 95 weight percent, based on the weight of the composition; the concentration of the at least one dialkoxysilane is in the range of from 0.1 to 3 weight percent, based on the weight of the composition; and the weight-to-weight ratio of the second silane modified polymer to the first silane modified polymer is in the range of from 0.8 to 3.0.

The present invention addresses a need in the art by providing a composition that can be used as a thermal interface material with desirable properties and low toxicity.

### DETAILED DESCRIPTION OF THE INVENTION

The present invention is a composition comprising a) a thermally conductive filler; b) a first silane modified polymer functionalized with at least two C₁-C₄-alkyl-di-C₁-C₄-alkoxysilyl groups or two tri-C₁-C₄-alkoxysilyl groups; c) a second silane modified polymer functionalized with one C₁-C₄-alkyl-di-C₁-C₄-alkoxysilyl group or one tri-C₁-C₄-alkoxysilyl group; and d) at least one dialkoxysilane selected from the group consisting of di-C₁-C₁₂-alkyl-di-C₁-C₄-alkoxysilanes and amino-C₁-C₁₂-alkyl-C₁-C₁₂-alkyl-di-C₁-C₄-alkoxysilanes;
wherein the concentration of the thermally conductive filler is in the range of from 70 to 95 weight percent, based on the weight of the composition; the concentration of the at least one dialkoxysilane is in the range of from 0.1 to 3 weight percent, based on the weight of the composition; and the weight-to-weight ratio of the second silane modified polymer to the first silane modified polymer is in the range of from 0.8 to 3.0.

As used herein, “a thermally conductive filler” refers to at least one thermally conductive filler. Examples of suitable thermally conductive fillers include zinc oxide; hydrates, hydroxides, and oxides of aluminum such as aluminum oxide (alumina) and aluminum trihydroxide (ATH); aluminum; boron nitride; aluminum nitride; magnesium oxide; magnesium hydroxide; silver; amorphous carbon; graphite; and aluminosilicates; and combinations thereof. The concentration of the thermally conductive filler is preferably in the range of from 80 to 90 weight percent, based on the weight of the composition.

The first and second silane modified polymers (SMPs) include polyethers such as polyethylene oxides and polypropylene oxides; polybutadienes; polycarbonates; polyacrylates; polyurethanes; and polyesters. The first SMP is preferably functionalized with at least two C₁-C₄-alkyl-di-C₁-C₂-alkoxylsilyl groups, or two C₁-C₂-alkyl-di-C₁-C₂-alkoxysilyl groups, or two terminal methyldimethoxysilyl groups. The second SMP is preferably functionalized with one C₁-C₄-di-C₁-C₂-alkoxylsilyl group, or one C₁-C₂-alkyl-di-C₁-C₂-alkoxysilyl group, or one methyldimethoxysilyl group, or one tri-C₁-C₂-alkoxysily group, or one trimethoxysilyl group. The weight-to-weight ratio of the second SMP to the first SMP is in the range of from 0.8 or from 1.0 to 3.0 or to 1.9. The concentration of the sum of the first and second polymers is typically in the range of from 5 weight percent, to 20 or to 15 weight percent, based on the weight of the composition.

The composition further comprises one or more dialkoxysilanes. A first dialkoxysilane is represented by structure I:

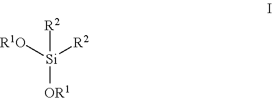

where each R¹ is independently C₁-C₄-alkyl, preferably C₁-C₂-alkyl; and each R² is independently C₁-C₁₂-alkyl. An example of a suitable first dialkoxysilane is n-octylmethyldimethoxysilane.

A second dialkoxysilane is represented by the following structure II:

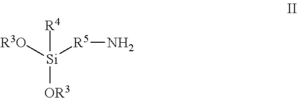

where each R³ is independently C₁-C₄-alkyl, preferably C₁-C₂-alkyl; R⁴ is C₁-C₁₂-alkyl; and R⁵ is a bivalent C₁-C₁₂-alkylene or a C₂-C₄-alkylene group. An example of a second alkoxysilane is 3-aminopropyl-methyl-dimethoxysilane.

The total concentration of the at least one dialkoxysilane is in the range of from 0.1 to 3 weight percent, based on the weight of the composition. When the composition comprises both the first and the second dialkoxysilane, which is preferred for optimal cure time, the concentration of the first dialkoxysilane is typically in the range of from 0.5 to 2.0 weight percent, based on the weight of the composition; and the concentration of the second dialkoxysilane is typically in the range of from 0.1 or from 0.2, to 1 or to 0.8 or to 0.6 weight percent based on the weight of the composition.

When the composition comprises the first and the second dialkoxysilanes, the weight-to-weight ratio of the second alkoxysilane to the first alkoxysilane is preferably in the range of from 0.15:1 or from 0.20:1 or from 0.25:1, to 0.65:1 or to 0.50:1 or to 0.45:1.

The composition of the present invention is useful as an intermediate for a curable composition, which further comprises a plasticizer, a condensation catalyst, water, and an antioxidant. A plasticizer is a substance added to a material to decrease its viscosity and hardness. Examples of plasticizers include esters such as phthalates, terephthalates, adipates, glycols, polyalkylene glycols, glycol ether esters, and low viscosity polyethers. The plasticizer is typically used at a concentration in the range of from 0.2 or from 0.5 or from 1.0 or from 2.0 weight percent, to 10 or to 8 or to 6 weight percent, based on the weight of the composition.

Suitable condensation catalysts include organotin catalysts such as dibutyltin dilaurate and dibutyltin diacetate, and bismuth catalysts such as bismuth octoate, at a concentration preferably in the range of from 0.01 or from 0.05 weight percent, to 1.0 or to 0.5 or to 0.2 weight percent, based on the weight of the composition.

Water is present in the curable composition at a concentration of from 0.1 or from 0.5 weight percent, to 2.0 or to 1.2 weight percent, based on the weight of the composition. The antioxidant is present in the curable composition at a concentration preferably in the range of from 0.05 or from 0.2 weight percent, to 1.0 or to 0.5 weight percent, based on the weight of the composition. Di-C₆-C₁₆-diphenyl amines are examples of suitable antioxidants, a commercial example of which is Irganox 5057 Antioxidant (bis(4-octylphenyl)amine).

The curable composition of the present invention is advantageously prepared by blending two pre-prepared intermediate compositions as follows: A first intermediate composition (Part A) is advantageously prepared by mixing in a vessel a plasticizer and a portion of one or more thermally conductive fillers, followed by heating the mixture under vacuum. After the contents of the vessel are cooled, catalyst and water are then added to the vessel with additional mixing.

A second intermediate composition (Part B) is advantageously prepared by admixing the first and second silane modified polymers, antioxidant, and the remainder of the one or more fillers, followed by heating the mixture under vacuum. The one or more dialkoxysilanes are then added to the mixture with further mixing. Parts A and B are then advantageously mixed, typically by static or active mixing methods well known in the art, at a Part A:Part B w/w ratio preferably in the range of from 20:1 or from 10:1 or from 2:1, or from 1:1, to 1:2, 1:5 or 1:10, or 1:20, then used as a curable interlayer between a heat generating substrate such as a battery or a semiconductor chip, and a heat sink substrate. This multilayered article is advantageously prepared by applying the mixed 2-component composition onto one of the substrates, then pressing the other substrate against the composition to spread the composition into a uniform layer, then allowing the composition to cure.

Accordingly, in another aspect, the present invention is a multilayered article comprising a heat sink substrate, a cured or curable interlayer superposing the heat sink substrate, and a heat generating substrate superposing the interlayer.

The curable composition of the present invention has been found to pass performance criteria of sufficiently low squeeze force, cure time, and cure hardness, at a targeted thermal conductivity value.

### EXAMPLES

### Example 1—Preparation of Curable Silane Modified Polymer Composition

### Part A Preparation

A first component (Part A) was prepared by the following steps: Plasthall 190 Plasticizer (10.28 g) and ZOCO 104 ZnO particles (17.57 g) were added to a 100MAX Flacktek speed mixer cup, which was covered with a lid. The contents were mixed for 20 s at 1800 rpm using a Flacktek speed mixer. DAM-40K Alumina particles (32.98 g) were then added to the cup and the contents were mixed in the speed mixer for 30 s at 2000 rpm. MX 200 Aluminum trihydroxide powder (36.87 g) was then added to the cup and the contents were mixed in the speed mixer for 30 s at 1500 rpm, then for an additional 10 s at 2000 rpm. The lid was removed and the cup was placed in a vacuum chamber pre-heated to 80 °C. The chamber was evacuated to 50 Torr and the contents were held in the chamber for 1 h. The cup was then removed from the chamber and covered with the lid then allowed to cool to room temperature.

Dibutyltin laureate (0.29 g) and D.I. water (2.00 g) were added to the cup, and the contents were mixed in the speed mixer for 20 s at 2000 rpm. The contents of the cup were then manually stirred then mixed in the speed mixer for an additional 5 s at 2000 rpm.

### Part B Preparation

A second component (Part B) was prepared by the following steps:

Bis-(methyldimethoxysilyl)-terminated polypropylene oxide having a dynamic viscosity of 600 mPa·s (SMP 1, 7.08 g), mono-(methyldimethoxysilyl)-terminated polypropylene oxide having a dynamic viscosity or 1000 mPa·s (SMP 2, 5.66 g), Irganox 5057 Antioxidant (0.53 g) and ZOCO 104 ZnO particles (17.04 g) were added to the 100MAX Flacktek speed mixer cup, which was covered with a lid. The contents were mixed for 20 s at 1800 rpm using a Flacktek speed mixer. DAM-40K Alumina particles (31.98 g) were then added to the cup and the contents were mixed in the speed mixer for 30 s at 2000 rpm. MX 200 Aluminum trihydroxide powder (35.76 g) was then added to the cup and the contents were mixed in the speed mixer for 30 s at 1500 rpm, then for an additional 10 s at 2000 rpm. The lid was removed and the cup placed in a vacuum chamber pre-heated to 80 °C. The chamber was evacuated to 50 Torr and the contents were held in the chamber for 1 h. The cup was then removed from the chamber and covered with the lid then allowed to cool to room temperature.

n-Octylmethyldimethoxysilane (OMDMS, 1.45 g) and 3-aminopropyldimethoxysilane (APMDMS, 0.50 g) were added to the cup. The cup was covered, and the contents mixed in the speed mixer for 20 s at 2000 rpm. The contents of the cup were then manually stirred then mixed in the speed mixer for an additional 5 s at 2000 rpm.

### Preparation of the Composition

A portion of Part A (15.00 g) and a portion of Part B (28.66 g) were added to a speed mixer cup. The cup was covered with a lid and mixed in the speed mixer for 20 s at 1800 rpm. The contents of the cup were stirred manually, then mixed in the speed mixer for an additional 5 s at 1500 rpm.

The blend of Parts A and B was immediately transferred onto a dammed square-shaped Teflon plate. The poured composition was leveled through light tapping of the plate.

### Comparative Example 1—Preparation of Curable Silane Modified Polymer Composition

Part A was prepared as described in Example 1. Part B was prepared as described in Example 1 except that Polymer 1 (12.74 g) was the sole polymer used.

### Comparative Example 2—Preparation of Curable Silane Modified Polymer Composition

Part A was prepared as described in Example 1. Part B was prepared as described in Example 1 except that Polymer 2 (12.74 g) was the sole polymer used.

Examples 2-5 were prepared essentially as described in Example 1 except that the relative amounts of Polymer 1 and Polymer 2 were varied, with the sum of the total polymer amounts being kept constant. Table 1 shows the relative amounts by weight of the components of the blends of Part A and Part B at the instant the parts are combined. SMP2:SMP1 refers to the w/w ratio of SMP2 to SMP1.

TABLE 1
SMP Compositional Makeup

| Material | CE1 | IE1 | IE2 | IE3 | IE4 | IE5 | CE2 |
|---|---|---|---|---|---|---|---|
| SMP 1 | 100 | 55.6 | 45.4 | 40 | 35.7 | 32.3 | 0 |
| SMP 2 | 0 | 44.4 | 54.6 | 60 | 64.3 | 67.7 | 100 |
| OMDMS | 11.4 | 11.4 | 11.4 | 11.4 | 11.4 | 11.4 | 11.4 |
| APMDMS | 3.9 | 3.9 | 3.9 | 3.9 | 3.9 | 3.9 | 3.9 |
| Plasticizer | 42.2 | 42.2 | 42.2 | 42.2 | 42.2 | 42.2 | 42.2 |
| ZnO | 205.9 | 205.9 | 205.9 | 205.9 | 205.9 | 205.9 | 205.9 |
| Alumina | 286.6 | 286.6 | 286.6 | 286.6 | 286.6 | 286.6 | 286.6 |
| ATH | 432.2 | 432.2 | 432.2 | 432.2 | 432.2 | 432.2 | 432.2 |
| Antioxidant | 4.2 | 4.2 | 4.2 | 4.2 | 4.2 | 4.2 | 4.2 |
| Catalyst | 1.2 | 1.2 | 1.2 | 1.2 | 1.2 | 1.2 | 1.2 |
| Water | 8.2 | 8.2 | 8.2 | 8.2 | 8.2 | 8.2 | 8.2 |
| SMP2:SMP1 | 0 | 0.8 | 1.2 | 1.5 | 1.8 | 2.1 | ∞ |

### Cure Hardness Measurements

A fresh mixture of Part A and Part B was poured onto a Teflon plate. Cure hardness was determined as the median value of five measurements using a Shore A dual durometer. Four pieces, each having a thickness of ~1 mm, were stacked prior to making the measurements. A sample was considered cured when no residue transferred to a gloved finger pressing lightly on slab, which can also be peeled off the Teflon plate with a spatula.

### Thermal Conductivity Measurement

Thermal conductivity was measured from cured slabs using a Hot Disk TPS2500 unit, following ISO 22007-2 standard.

Cure times, cure hardness, and thermal conductivities (TC) were measured for the samples and shown in Table 2. Cure hardness is measured in units of Shore A; a cured coating with a Shore A index between 2 and 65 passed the hardness requirement. Samples that cured within 2 weeks passed the cure time requirement (P); samples that cured within 24 hours were especially desirable (Hi P). Samples that cured beyond 2 weeks failed the cure test (F).

TABLE 2
Properties of Cured Coatings

| Property | CE1 | IE1 | IE2 | IE3 | IE4 | IE5 | CE2 |
|---|---|---|---|---|---|---|---|
| Cure time | P | P | Hi P | Hi P | Hi P | Hi P | F |
| Cure hardness | 78 | 65 | 44 | 44 | 36 | 26 | 0 |
| TC | 2.1 | 2.1 | 2.1 | 2.2 | 2.0 | 2.1 | N/A |

Examples 6-9 were prepared as in Example 2 except that the ratio of the dialkoxysilanes OMDMS and APMDMS were varied as shown in Table 3.

TABLE 3
Effect of Cure Hardness and Cure Time on
Relative Amounts of Dialkoxysilanes

| Ingredient Type | IE6 | IE7 | IE2 | IE8 | IE9 |
|---|---|---|---|---|---|
| OMDMS | 15.3 | 13.3 | 11.4 | 9.4 | 0 |
| APMDMS | 0 | 2 | 3.9 | 5.9 | 15.3 |
| OMDMS:APMDMS | 0 | 0.15:1 | 0.35:1 | 0.63:1 | ∞ |
| Cure time | P | P | Hi P | Hi P | Hi P |
| Cure hardness | 10 | 25 | 44 | 60 | 52 |

The data demonstrate that acceptable cure hardness is achievable with either or both of the dialkoxysilanes, and that the most desirable cure times were achieved using a combination of the dialkoxysilanes.

1. A composition comprising a) a thermally conductive filler; b) a first silane modified polymer functionalized with at least two C₁-C₄-alkyl-di-C₁-C₄-alkoxysilyl groups or two tri-C₁-C₄-alkoxysilyl groups; c) a second silane modified polymer functionalized with one C₁-C₄-alkyl-di-C₁-C₄-alkoxysilyl group or one tri-C₁-C₄-alkoxysilyl group; and d) at least one dialkoxysilane selected from the group consisting of di-C₁-C₁₂-alkyl-di-C₁-C₄-alkoxysilanes and amino-C₁-C₁₂-alkyl-C₁-C₁₂-alkyl-di-C₁-C₄-alkoxysilanes;
wherein the concentration of the thermally conductive filler is in the range of from 70 to 95 weight percent, based on the weight of the composition; the concentration of the at least one dialkoxysilane is in the range of from 0.1 to 3 weight percent, based on the weight of the composition; and the weight-to-weight ratio of the second silane modified polymer to the first silane modified polymer is in the range of from 0.8 to 3.0.

2. The composition of claim 1 where the thermally conductive filler is one or more fillers selected from the group consisting of zinc oxide, alumina, aluminum trihydroxide, aluminum, boron nitride, aluminum nitride, magnesium oxide, magnesium hydroxide, silver, amorphous carbon, graphite, and aluminosilicates; and the silane modified polymers are selected from the group consisting of polyethers, polybutadienes, polycarbonates, polyacrylates, polyurethanes, and polyesters.

3. The composition of claim 2 wherein the first silane modified polymer is functionalized with at least two C₁-C₄-alkyl-di-C₁-C₂-alkoxylsilyl groups and the second silane modified polymer is functionalized with one C₁-C₄-di-C₁-C₂-alkoxylsilyl group.

4. The composition of claim 3 wherein the first silane modified polymer is functionalized with two C₁-C₂-alkyl-di-C₁-C₂-alkoxysilyl groups and the second silane modified polymer is functionalized with one C₁-C₂-alkyl-di-C₁-C₂-alkoxysilyl group; and the thermally conductive filler is a mixture of zinc oxide, alumina, and aluminum trihydroxide.

5. The composition of claim 4 wherein the at least one dialkoxysilane is a mixture of a first dialkoxysilane, which is a di-C₁-C₁₂-alkyl-di-C₁-C₄-alkoxysilane and a second dialkoxysilane, which is an amino-C₁-C₁₂-alkyl-C₁-C₁₂-alkyl-di-C₁-C₄-alkoxysilane.

6. The composition of claim 5 wherein the di-C₁-C₁₂-alkyl-di-C₁-C₄-alkoxysilane is n-octylmethyldimethoxysilane and the amino-C₁-C₁₂-alkyl-C₁-C₁₂-alkyl-di-C₁-C₄-alkoxysilane is 3-aminopropyl-methyl-dimethoxysilane; wherein the weight-to-weight ratio of the second dialkoxysilane to the first dialkoxysilane is in the range of from 0.15:1 to 0.65:1.

7. The composition of claim 6 wherein the weight-to-weight ratio of the second dialkoxysilane to the first dialkoxysilane is in the range of from 0.20:1 to 0.50:1.

8. The composition of claim 1 wherein the silane modified polymer is a silane modified polyethylene oxide or a silane modified polypropylene oxide.

9. The composition of claim 1 which is a curable composition that further comprises a plasticizer, a condensation catalyst, water, and an antioxidant.

10. A multilayered article comprising a heat sink substrate, a curable interlayer superposing the heat sink substrate, and a heat generating substrate superposing the interlayer, wherein the curable interlayer is the composition of claim 1.

11. The multilayered article of claim 10 wherein the curable interlayer is cured.
